(19) United States
(12) Patent Application Publication
(10) Pub. No.: US 2015/0128669 A1
(43) Pub. Date: May 14, 2015

(54) PROTECTION MECHANISM OF A DOOR'S KEY HOLE

(71) Applicant: Georgios Chrimatopoulos, Drosia Attikis (GR)

(72) Inventor: Georgios Chrimatopoulos, Drosia Attikis (GR)

(21) Appl. No.: 14/398,734

(22) PCT Filed: Apr. 29, 2013
(86) PCT No.: PCT/GR2013/000024

§ 371 Date: Nov. 4, 2014

(30) Foreign Application Priority Data
May 8, 2012 (GR) 20120100246

(51) Int. Cl. E05B 17/14

(52) U.S. Cl. CPC E05B 17/147
USPC 70/455

(57) ABSTRACT

Protection mechanism of the key hole of the lock of a door (11) consisting of a tough durable shell (1), within which a mechanism that drives a blade (4) to cover the key hole (11) is located, so that the key hole will not be visible to any attacker and will not be exposed to the weather conditions. The hitherto mechanisms let the key hole of the lock exposed.

This invention refers to a mechanism placed outside of a door which protects the lock by covering the key hole.

The hitherto existing technique does not prevent the involvement of the prospective intruder with the key hole.

This invention consists of a hollow beam of stainless or galvanized steel, or a tube of stainless or galvanized steel, in which the mechanism is placed. The mechanism is controlled by an electrical or wireless signal and moves a blade which covers the key hole outside of the door.

The whole system is mounted to the entrance door unbending, with stainless steel screws and nuts.

The present invention eliminates the possibility of invasion to the key hole, as it is impossible to violate the mechanism by conventional means.

Due to the high rate of burglaries derived from the violation of the key hole of the door's lock, the usual protection of residences is internal, by placing bolts or pins. The usual technique secures the house only when the occupants are inside.

With this invention the safety and security of the building is maximized during the absence of the occupants, since the mechanism is wirelessly controlled.

A further advantage of the present invention is the ability of relatives or friends to enter into the residence of incapacitated elderly without reducing the security of the door.

The main mechanism, which is located inside a galvanized or stainless steel hollow beam or tube, consists of the following: a 60×8 mm stainless steel blade that after receiving the signal exits the shell and covers the key hole by entering into a hole in the adjacent door frame (12), an electric Linear Actuator 6V-12V-24V which pushes or pulls the blade upon receiving the signal.

The signal to the linear actuator is given wirelessly from a remote control with rolling codes. Inside the shell is also placed a 6V-12V-24V battery to provide power when there is a black out. The main power supply to the mechanism is made from the inside of the house with a suitable 230—6V-12V-24V converter which simultaneously keeps the battery charged.

The present invention can be implemented easily by following the next detailed description and drawings.

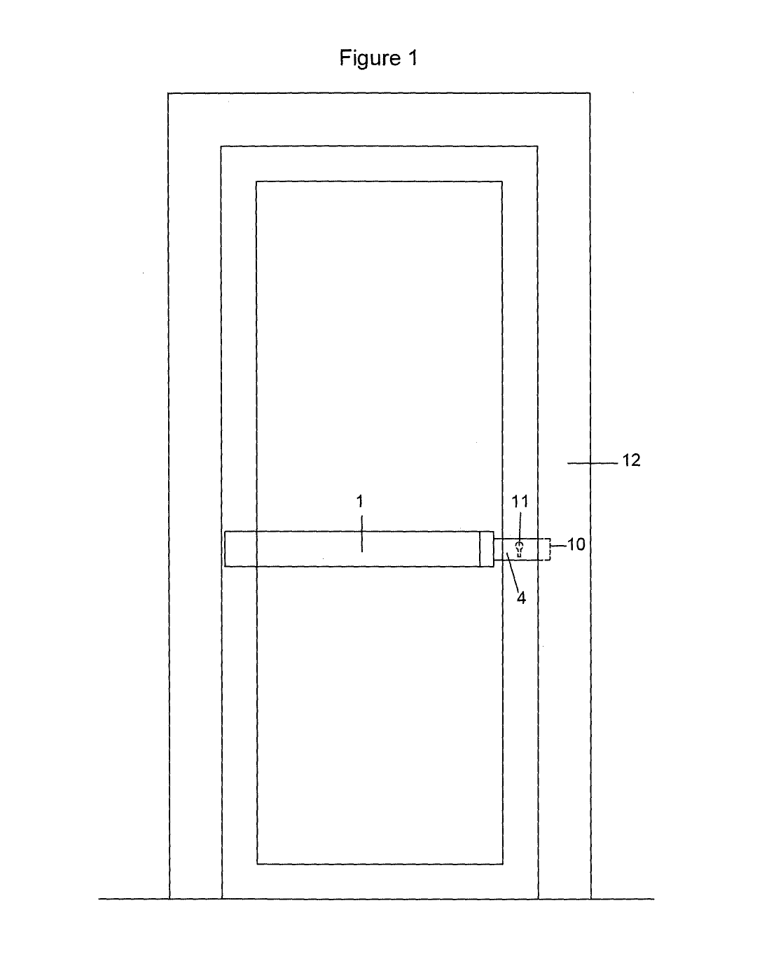

FIG. 1 shows the position of the beam on a standard door.

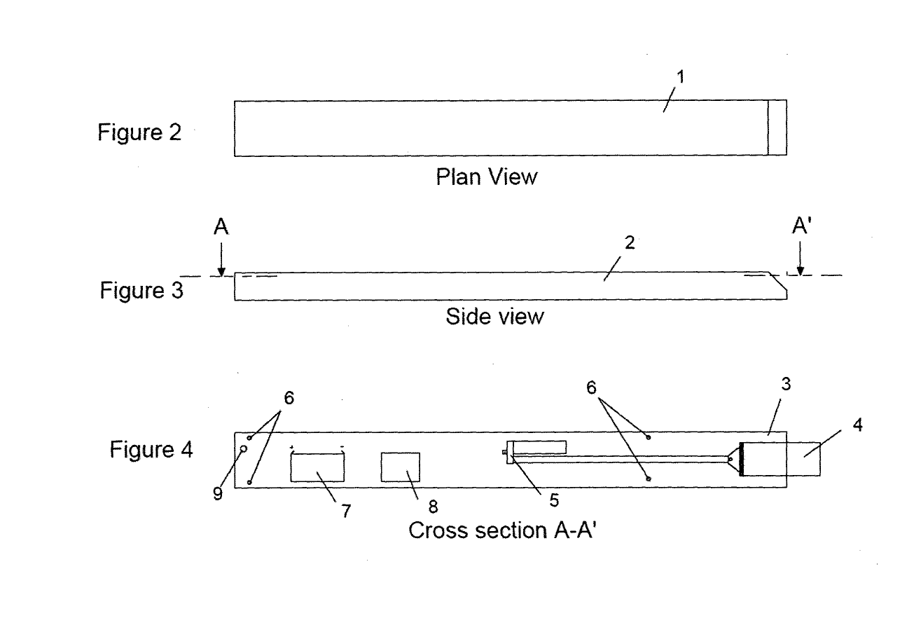

FIG. 2 shows a plan view of the beam.

FIG. 3 shows a side view of the beam.

FIG. 4 shows the internal mechanism of the beam.

The mechanism consists of the following:
1. The easel (3) in which the 60×8 mm stainless steel blades (4) is moving, which covers the key hole of the lock (11).
2. The main element for linear motion the Linear Actuator (5).
3. The battery 6V-12V-24V (7).
4. The receiver (8), which receives the signal from the transmitter (remote control).
5. A hole (9) for the cables to run through to the house for charging the battery. The state of charge of the battery will be checked with the suitable visual instrument.
6. Stainless-steel screws (6) for supporting the shell rigidly to the door.

1. Protection mechanism of the key hole of a lock of an external or internal door made by stainless blade which moves covering the key hole of the lock entering to a hole in the door frame. The signal is given by a remote control or electrically.

2. The mechanism according to claim 1 may be located within a hollow beam or tube or composite structure of wood and stainless steel and can be painted or galvanized or covered with veneer wood.

3. The moving element can be a blade, a part of hollow beam or a pipe made of stainless steel, galvanized steel, aluminum or normal steel or high resistance to abrasion steel.
